(19) United States
(12) Patent Application Publication
(10) Pub. No.: US 2008/0282237 A1
(43) Pub. Date: Nov. 13, 2008

(54) Method and Apparatus For Generating Execution Equivalence Information

(76) Inventors: Jinquan Dai, Shanghai (CN); Long Li, Shanghai (CN); Bo Huang, Shanghai (CN)

Correspondence Address: LAWRENCE CHO;C/O Intellevate, LLC, P. O. BOX 52050, MINNEAPOLIS, MN, 55402, US

(21) Appl. No.: 11/547,350

(22) PCT Filed: Jan. 14, 2005
(86) PCT No.: PCT/CN2005/000062

§ 371 Date: Sep. 29, 2006

(51) Int. Cl. G06F 9/45

(52) U.S. Cl. 717/156; 717/140; 717/151

(57) ABSTRACT

A method of compiling code includes identifying blocks of code that are execution equivalence pairs. Other embodiments are described and claimed.

### FIELD

An embodiment of the present invention relates to compilers. More specifically, an embodiment of the present invention relates to a method and apparatus for generating execution equivalence information that may be used by a compiler to optimize the compilation of code.

### BACKGROUND

Program dependence graphs (PDGs) provide an intermediate program representation that illustrate both the essential data dependencies and control dependencies for operations in a program without the unnecessary sequencing presented in a control flow graph of a program. In PDGs, data dependencies are used to represent only the relevant data flow relationships of a program, and control dependencies are introduced to analogously represent only the essential control flow relationships of a program.

The time complexity for generating a PDG for a program is given by the relationship O(N×E), where N represents the number of nodes or blocks in the control flow graph (CFG) of the program and E represents the number of edges connecting the blocks in the CFG. The PDG for large programs would require a large period of time to generate. This is undesirable for compilers that utilize information from the PDG to optimize compilation of code. PDGs also suffer the drawback of not including information about a program's structure. When performing global instruction scheduling, vectorization, critical section minimization, and incremental data flow analysis on a program, the compiler is required to perform additional analysis on the program to obtain information about the program's structure not provided by the PDG. Thus, additional time is required for the analysis when attempting to improve the efficiency of various program transformations when using PDGs.

Thus, what is needed is a method and apparatus for generating execution equivalence information that may be used by a compiler to efficiently optimize code during compilation.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of an exemplary computer system in which an example embodiment of the present invention may be implemented.

FIG. 2 is a block diagram that illustrates a compiler according to an example embodiment of the present invention.

FIG. 3 is a block diagram of an execution equivalence information generator according to an example embodiment of the present invention.

FIG. 4 is an example control flow diagram that may be processed by an execution equivalence information generator unit according to an example embodiment of the present invention.

FIG. 5 is a flow chart of a method for generating execution equivalence information according to an example embodiment of the present invention.

FIG. 6 is a flow chart of a method for identifying immediate execution equivalence pairs according to an example embodiment of the present invention.

FIG. 7 is a flow chart of a method for identifying an immediate sentinel block for a block outside a loop according to an example embodiment of the present invention.

FIG. 8 is a flow chart of a method for identifying an immediate sentinel block for a block inside a loop according to an example embodiment of the present invention.

FIG. 9 is an exemplary control tree according to an embodiment of the present invention.

### DETAILED DESCRIPTION

In the following description, for purposes of explanation, specific nomenclature is set forth to provide a thorough understanding of embodiments of the present invention. However, it will be apparent to one skilled in the art that specific details in the description may not be required to practice the embodiments of the present invention. In other instances, well-known components, programs, and procedures are shown in block diagram form to avoid obscuring embodiments of the present invention unnecessarily.

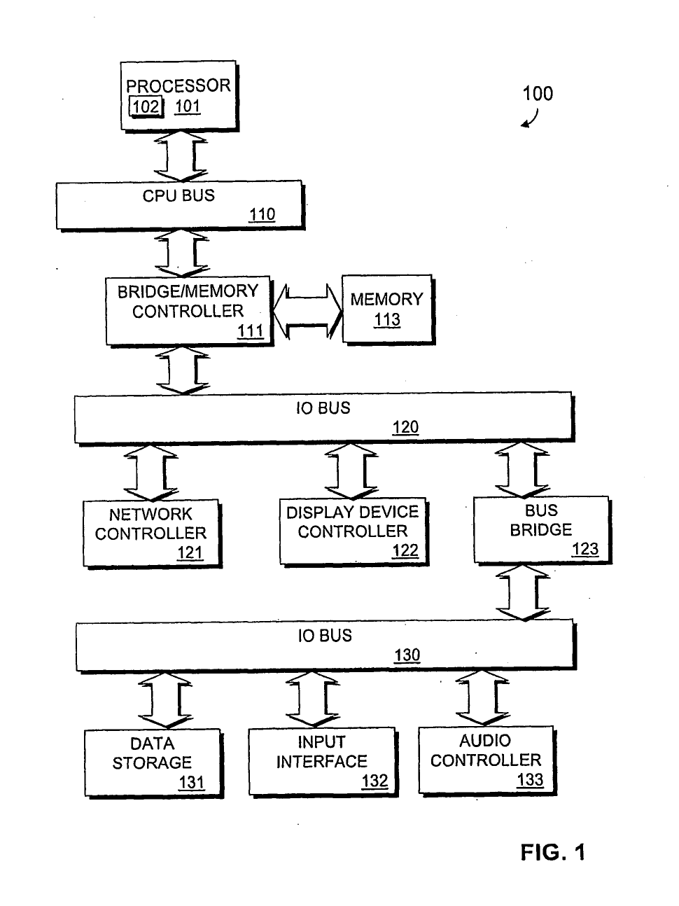

FIG. 1 is a block diagram of an exemplary computer system 100 according to an embodiment of the present invention. The computer system 100 includes a processor 101 that processes data signals and a memory 113. The processor 101 may be a complex instruction set computer microprocessor, a reduced instruction set computing microprocessor, a very long instruction word microprocessor, a processor implementing a combination of instruction sets, or other processor device. FIG. 1 shows the computer system 100 with a single processor. However, it is understood that the computer system 100 may operate with multiple processors. Additionally, each of the one or more processors may support one or more hardware threads. The processor 101 is coupled to a CPU bus 110 that transmits data signals between processor 101 and other components in the computer system 100.

The memory 113 may be a dynamic random access memory device, a static random access memory device, read-only memory, and/or other memory device. The memory 113 may store instructions and code represented by data signals that may be executed by the processor 101. According to an example embodiment of the computer system 100, a compiler may be stored in the memory 113 and implemented by the processor 101 in the computer system 100. The compiler may generate execution equivalence information that may be used to optimize the compilation of code.

A cache memory 102 resides inside processor 101 that stores data signals stored in memory 113. The cache 102 speeds access to memory by the processor 101 by taking advantage of its locality of access. In an alternate embodiment of the computer system 100, the cache 102 resides external to the processor 101. A bridge memory controller 111 is coupled to the CPU bus 110 and the memory 113. The bridge memory controller 111 directs data signals between the processor 101, the memory 113, and other components in the computer system 100 and bridges the data signals between the CPU bus 110, the memory 113, and a first IO bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds and is also coupled to the IO bus 130. A bus bridge 123 couples the first IO bus 120 to the second IO bus 130. The bus bridge 123 operates to buffer and bridge data signals between the first IO bus 120 and the second IO bus 130.

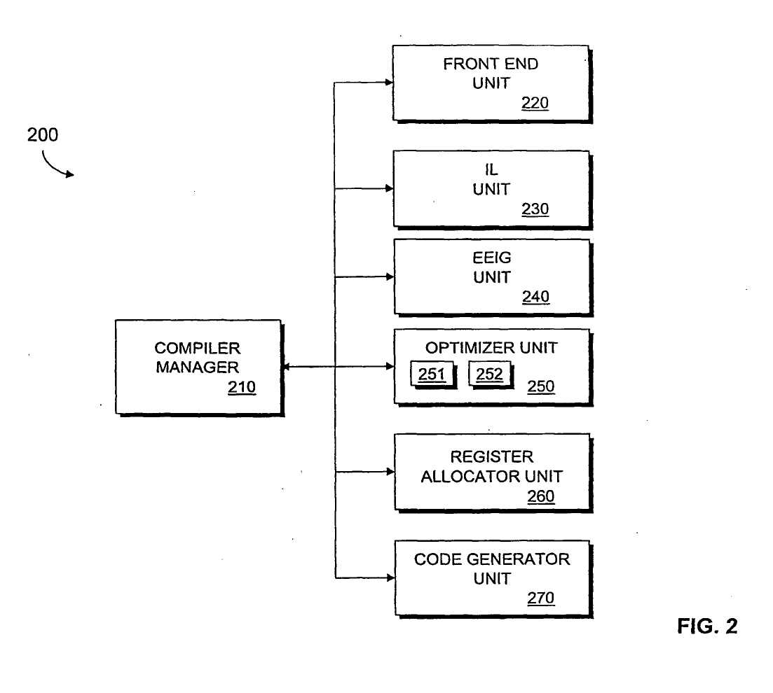

FIG. 2 is a block diagram that illustrates a compiler 200 according to an example embodiment of the present invention. The compiler 200 includes a compiler manager 210. The compiler manager 210 receives source code to compile. The compiler manager 210 interfaces with and transmits information between other components in the compiler 200.

The compiler 200 includes a front end unit 220. According to an embodiment of the compiler 200, the front end unit 220 operates to parse source code and convert it to an abstract syntax tree.

The compiler 200 includes an intermediate language unit 230. The intermediate language unit 230 transforms the abstract syntax tree into a common intermediate form such as an intermediate representation. It should be appreciated that the intermediate language unit 230 may transform the abstract syntax tree into one or more common intermediate forms.

The compiler 200 includes an execution equivalence information generator (EEIG) unit 240. The execution equivalence generator unit 240 generates execution equivalence information about a program from a program's control flow graph. The execution equivalence information may include a hierarchical summary of the structure of the program and illustrate dependencies in the program. In one embodiment, the execution equivalence information describes loop structures, control dependencies, data dependencies, and a hierarchical decomposition of the structure of a program. The execution equivalence information may identify basic blocks (a group of commands or statements that have a single entry and exit point) in the program that are execution equivalent successors and predecessors, immediate execution equivalent successors and predecessors, and immediate sentinels.

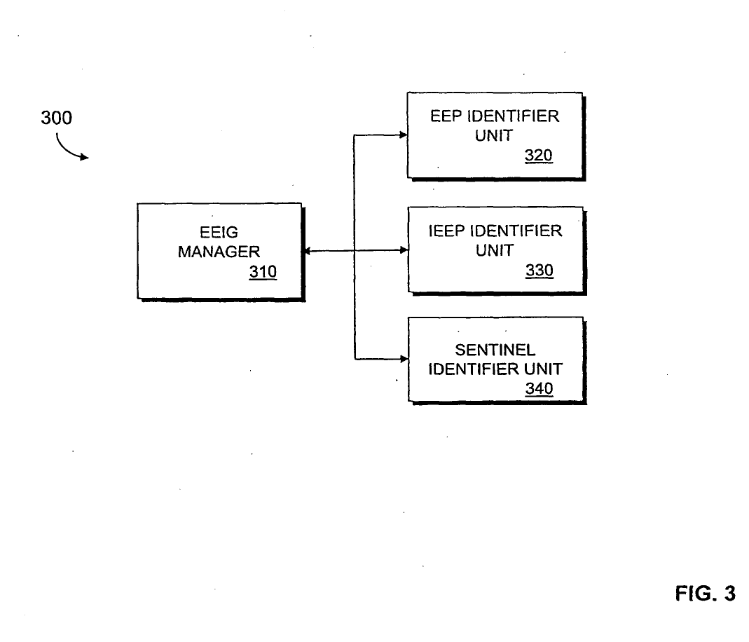

FIG. 3 is a block diagram of an execution equivalence information generator (EEIG) unit 300 according to an example embodiment of the present invention. The execution equivalence information generator unit 300 may be implemented as the execution information generator unit 240 shown in FIG. 2. The execution equivalence information generator unit 300 includes execution equivalence information generator (EEIG) manager 310. The execution equivalence information generator manager 310 generates a summarized control flow graph from a control flow graph of a program it receives. According to an embodiment of the present invention, the summarized control flow graph illustrates groups of strongly connected components that are numbered in topological order. The execution equivalence information generator manager 310 interfaces with and transmits information between other components in the execution equivalence information generator unit 300.

The execution equivalence information generator unit 300 includes an execution equivalence pair (EEP) identifier unit 320. The execution equivalence pair identifier unit 320 identifies blocks in the control flow graph of the program that are an execution equivalence pair. An execution equivalence pair includes a first block that is an execution equivalent successor of a second block and a second block that is an execution equivalent predecessor of a first block. According to an embodiment of the present invention, a block b is an execution equivalent successor of a block a (or equally a block a is an execution equivalent predecessor of block b) if the following three conditions are true. (1) Block a and block b are two different blocks. (2) Block a dominates block band block b post-dominates block a. (3) Neither block a nor block b is inside a loop, or both blocks a and b are contained in the same loop.

When blocks are execution equivalence pairs, one block is executed if and only if the other block in the pair is executed in the control flow. Both blocks have the same set of control conditions in the control dependence relationship and hence are control equivalent. Since blocks that are execution equivalence pairs are either in the same loop or are not in any loop at all, both blocks are executed with the same frequency.

The execution equivalence information generator unit 300 includes an immediate execution equivalence pair (IEEP) identifier unit 330. The immediate execution equivalence pair identifier unit 330 determines whether blocks that are identified to be an execution equivalence pair are an immediate execution equivalence pair. An immediate execution equivalence pair includes a first block that is an immediate execution equivalent successor of a second block and a second block that is an immediate execution equivalent predecessor of a first block. According to an embodiment of the present invention, block b is an immediate execution equivalent successor of block a (or equally block a is an immediate execution equivalent predecessor of block b) if the following two conditions are true. (1) Block b is an execution equivalent successor of block a. (2) Block b dominates every execution equivalent successor of block a.

The execution equivalence information generator unit 300 includes a sentinel identifier unit 340. The sentinel identifier unit 340 determines when a block is guarded. According to an embodiment of the execution equivalence information generator unit 300, the sentinel identifier unit 340 determines that a block c is guarded by blocks a and b if there is a path from black a to block c to block b, and block a and block b are execution equivalent pairs and define a single entry and exit points to block c. The sentinel identifier unit 340 also determines whether a first block in the program is a sentinel block to a second block in the program. According to an embodiment of the present invention, block a is a sentinel of block c if block c is guarded by block a and is guarded by an execution equivalent successor of block a. The sentinel identifier unit 340 also determines whether a first block in the program is an immediate sentinel block to a second block in the program. According to an embodiment of the present invention, block a is an immediate sentinel of block c if block c is guarded by block a and an immediate execution equivalent successor of block a.

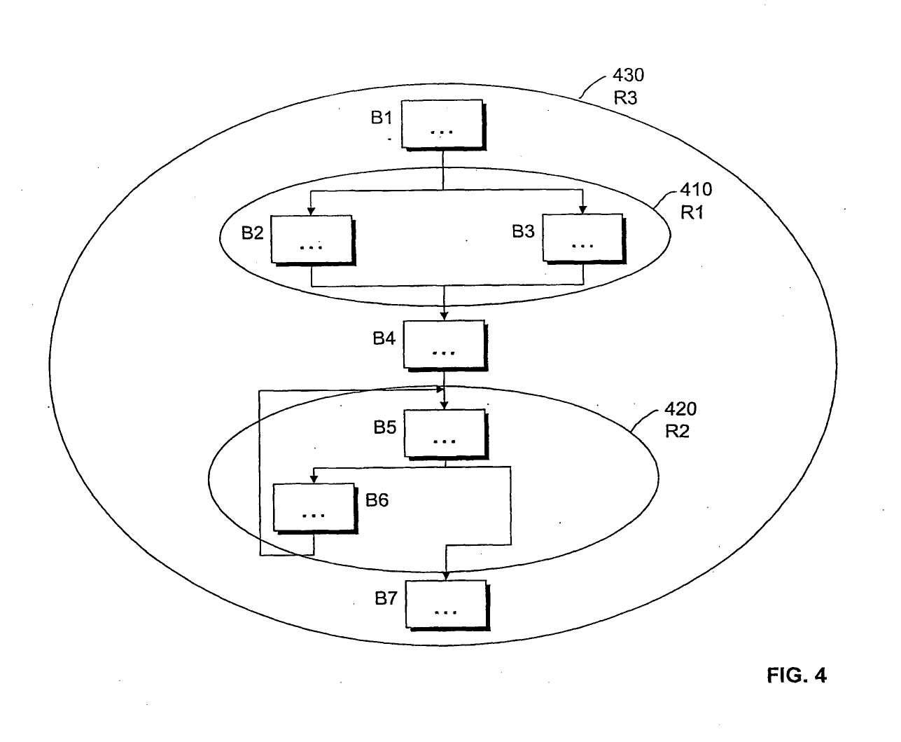

FIG. 4 is an example control flow diagram 400 that may be processed by an execution equivalence information generator according to an example embodiment of the present invention. The control flow diagram includes a plurality of blocks B1-B7. In this example, B1 is the immediate execution equivalent predecessor of B4, and B4 is the immediate execution equivalent successor of B1. B2 and B3 are guarded by B1 and B4. B1 is the immediate sentinel block of B2 and B3. This is illustrated by ring 410 R1. B4 is the immediate execution equivalent predecessor of B7. B7 is the immediate execution equivalent successor of B4. B5 and B6 are guarded by B4 and B7. B4 is the immediate sentinel block of B5 and B6. This is illustrated by ring 420 R2. B1 is an execution equivalent predecessor of B7. B7 is an execution equivalent successor of B1. B2, B3, B4, B5, and B6 are guarded by B1 and B7. B1 is a sentinel block of B2, B3, B4, B5, and B6.

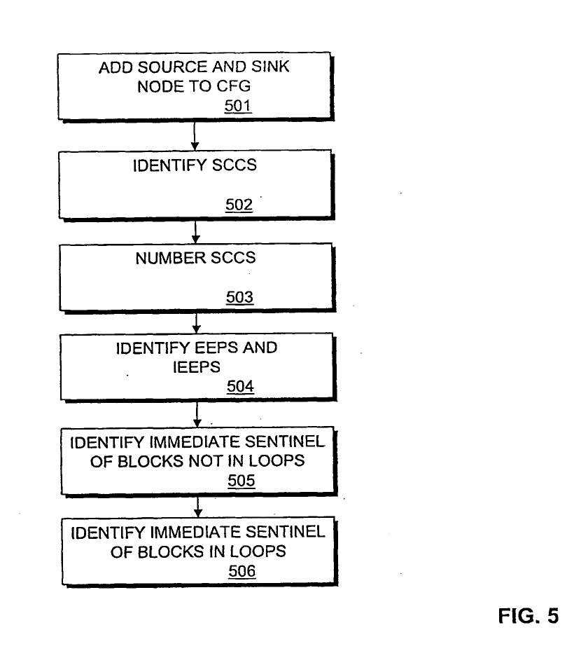

FIG. 5 is a flow chart of a method for generating execution equivalence information according to an example embodiment of the present invention. The method shown in FIG. 5 may be performed by the execution equivalence information generator unit 300 shown in FIG. 3. At 501, source and sink nodes are added to a control flow graph (CFG). According to an embodiment of the present invention, an artificial source node is prepended to the control flow graph and an artificial sink node is appended to the control flow graph of the program.

At 502, groups of strongly connected components (SCCs) are identified to generate a summarized control flow graph. According to an embodiment of the present invention, a strongly connected component may be a group of one or more blocks in a program that have a path to each member of the group. In this embodiment, a single block may be strongly connected component to itself.

At 503, the groups of strongly connected components are numbered in the summarized control flow graph. According to an embodiment of the present invention, the groups of strongly connected components are numbered from 1 to C in topological order, where C is the total number of groups of strongly connected components in the summarized control flow graph.

At 504, the execution equivalent pairs (EEPs) and immediate execution equivalent pairs (IEEPs) are identified where the pairs are not contained in any loop in the control flow graph. According to an embodiment of the present invention, immediate execution equivalent pairs block n and m are identified where m is the immediate execution equivalent predecessor of n and n is the immediate execution equivalent successor of m.

At 505, the immediate sentinel block of each block not contained in any loop in the control flow graph is identified. According to an embodiment of the present invention, the immediate sentinel block of each block k is identified.

At 506, the immediate execution equivalent blocks and immediate sentinel blocks for blocks contained in loops are identified.

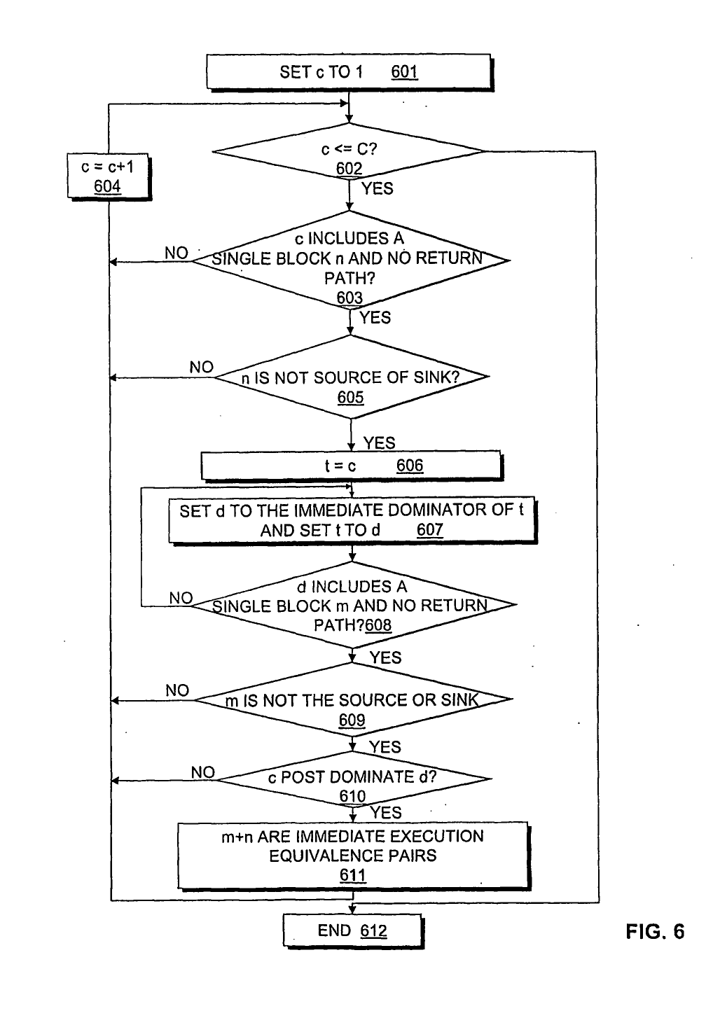

FIG. 6 is a flow chart of a method for identifying immediate execution equivalence pairs according to an example embodiment of the present invention. The method shown in FIG. 6 may be used at 504 shown in FIG. 5. At 601, variable c is set to 1. The variable c may be used to identify a current group of strongly connected components in the summarized control flow graph that is being evaluated.

At 602, it is determined whether all the groups of strongly connected components have been evaluated by determining whether c is less than or equal to C, where C is the total number of groups of strongly connected components in the summarized control flow graph. If c is less than or equal to C, control proceeds to 603. If c is not less than or equal to C, control proceeds to 612 and terminates the procedure.

At 603, it is determined whether the current group of strongly connected components being evaluated includes a single block n where block n does not have a return path to itself in the CFG. If it is determined that the current group of strongly connected components does not include a single block or does have a return path to itself, control proceeds to 604. If it is determined that the current group of strongly connected components includes a single block and does not have a return path to itself, control proceeds to 605.

At 604, the variable c is incremented. Control returns to 602.

At 605, it is determined whether block n is a source or sink of the summarized control flow graph. If it is determined that the block n is a source or sink of the summarized control flow graph, control returns to 604. If it is determined that the block n is not a source or sink of the summarized control flow graph, control proceeds to 606.

At 606, the variable t is assigned the value of c.

At 607, the variable d is assigned the immediate dominator of the block corresponding to the value t. The variable t is set to d.

At 608, it is determined whether the group of strongly connected components associated with the value d includes a single block m where block m does not have a return path to itself in the CFG. If it is determined that the group of strongly connected components associated with the value d does not include a single block or does have a return path to itself, control proceeds to 609. If it is determined that the group of strongly connected components associated with the value d includes a single block and does not have a return path to itself, control proceeds to 607.

At 609, it is determined whether block m is a source or sink of the summarized control flow graph. If it is determined that the block m is a source or sink of the summarized control flow graph, control returns to 604. If it is determined that the block m is not a source or sink of the summarized control flow graph, control proceeds to 610.

At 610, it is determined whether the strongly connected component associated with the value c post dominates the strongly connected component associated with the value d in the summarized CFG. If it is determined that the strongly connected components associated with the value c does not post dominates the strongly connected components associated with the value d, control returns to 604. If it is determined that the strongly connected components associated with the value c post dominates the strongly connected components associated with the value d, control proceeds to 611.

At 611, the blocks associated with the variables m and n are designated an immediate execution equivalent pair. The block associated with m is the immediate execution equivalent predecessor of the block associated with the variable n. The block associated with the variable n is the immediate execution equivalent successor of the variable m. Control returns to 604.

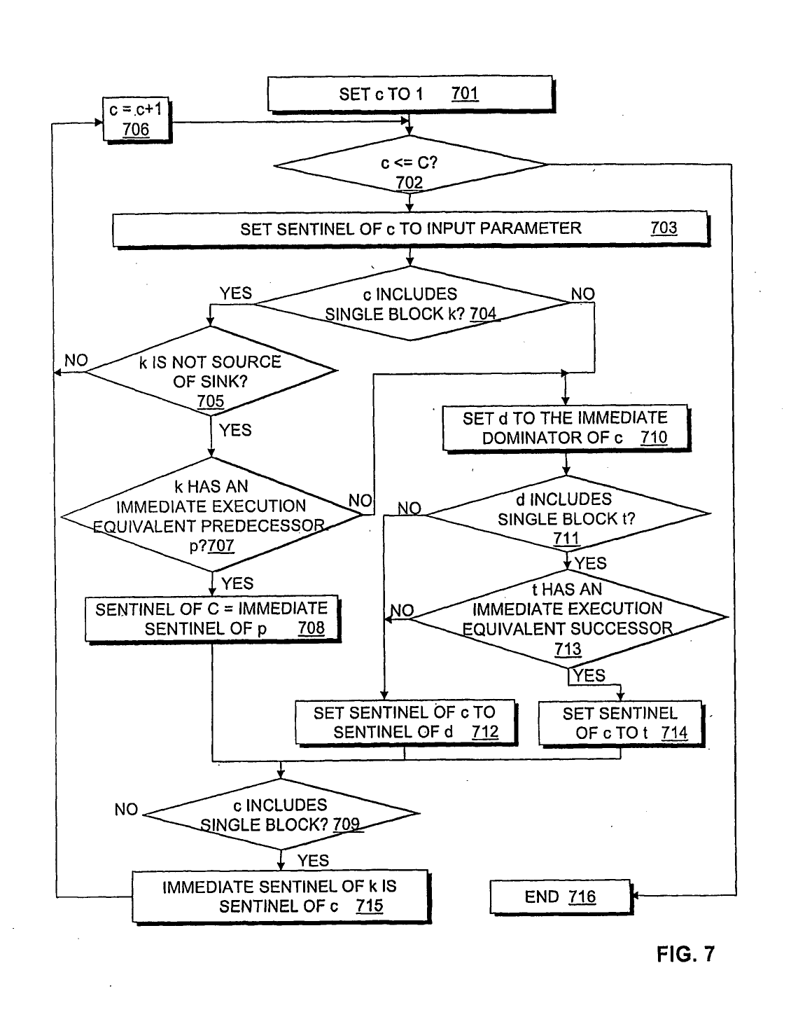

FIG. 7 is a flow chart of a method for identifying an immediate sentinel block for a block outside a loop according to an example embodiment of the present invention. The method illustrated in FIG. 7 may be implemented at 505 shown in FIG. 5. At 701, variable c is set to 1. The variable c may be used to identify a current group of strongly connected components in the summarized control flow graph that is being evaluated.

At 702, it is determined whether all the groups of strongly connected components have been evaluated by determining whether c is less than or equal to C, where C is the total number of groups of strongly connected components in the summarized control flow graph. If c is less than or equal to C, control proceeds to 703. If c is not less than or equal to C, control proceeds to 716 and terminates the procedure.

At 703, the sentinel for the group of strongly connected components associated with the variable c is set to input parameters. According to an embodiment of the present invention, the input parameter may be a source of the summarized control flow graph.

At 704, it is determined whether the group of strongly connected components associated with variable c includes a single block k. If it is determined that the group of strongly connected components associated with variable c includes a single block, control proceeds to 705. If it is determined that the group of strongly connected components associated with variable c does not include a single block, control proceeds to 710.

At 705, it is determined whether block k is a source or sink of the summarized control flow graph. If it is determined that the block k is a source or sink of the summarized control flow graph, control proceeds to 706. If it is determined that the block k is not a source or sink of the summarized control flow graph, control proceeds to 707.

At 706, the variable c is incremented. Control returns to 702.

At 707, it is determined whether block k has an immediate execution equivalent predecessor block. According to an embodiment of the present invention, this determination may be made at 504 shown in FIG. 5. If block k has an immediate execution equivalent predecessor block, the execution equivalent predecessor block is designated block p and control proceeds to 708. If block k does not have an immediate execution equivalent predecessor block, control proceeds to 710.

At 708, the sentinel of the strongly connected component associated with the variable c is set to the immediate sentinel of block p.

At 709, it is determined whether the group of strongly connected components associated with variable c includes a single block k. If it is determined that the group of strongly connected components associated with variable c includes a single block, control proceeds to 715. If it is determined that the group of strongly connected components associated with variable c does not include a single block, control proceeds to 706.

At 710, the variable d is set to the immediate dominator of the strongly connected components associated with the variable c in the summarized CFG.

At 711, it is determined whether the group of strongly connected components associated with the value d includes a single block t. If it is determined that the group of strongly connected components associated with the value t does not include a single block t, control proceeds to 712. If it is determined that the group of strongly connected components associated with the value d includes a single block, control proceeds to 713.

At 712, the sentinel of the strongly connected component associated with the variable c is set to the sentinel of the strongly connected component associated with the variable d.

At 713, it is determined whether the block t has an immediate execution equivalent successor. According to an embodiment of the present invention, the determination may be made at 504 shown in FIG. 5. If it is determined that the block t does not have an immediate execution equivalent successor, control proceeds to 712. If it is determined that the block t does have an immediate execution equivalent successor, control proceeds to 714.

At 714, the sentinel for the strongly connected component associated with the variable c is set to block t. Control proceeds to 709.

At 715, the immediate sentinel of block k is set to the sentinel of the closely connected component associated with the variable c.

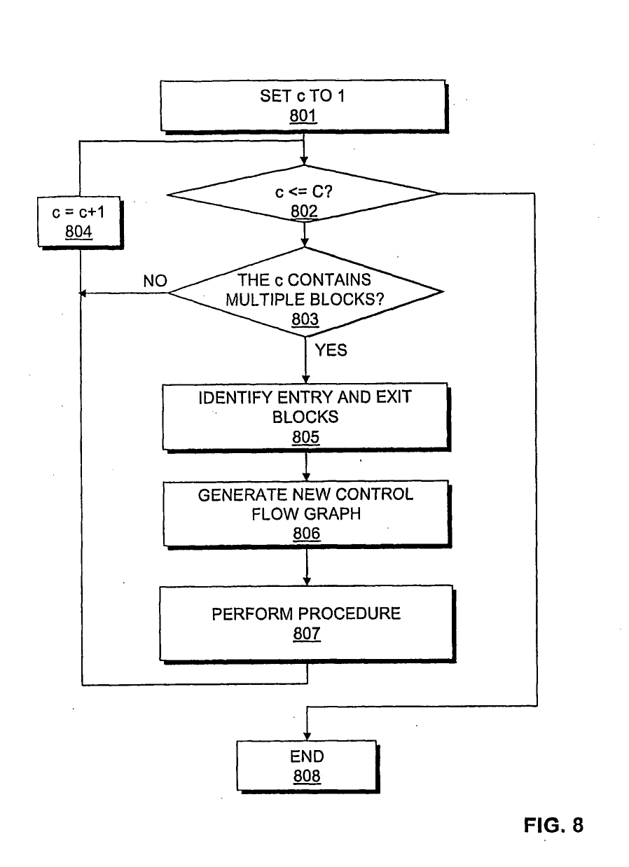

FIG. 8 is a flow chart of a method for identifying an immediate sentinel block for a block inside a loop according to an example embodiment of the present invention. The method illustrated in FIG. 8 may be implemented at 506 shown in FIG. 5. At 801, variable c is set to 1. The variable c may be used to identify a current group of strongly connected components in the summarized control flow graph that is being evaluated.

At 802, it is determined whether all the strongly connected components have been evaluated by determining whether c is less than or equal to C, where C is the total number of groups of strongly connected components in the summarized control flow graph. If c is less than or equal to C, control proceeds to 803. If c is not less than or equal to C, control proceeds to 716 and terminates the procedure.

At 803, it is determined whether the strongly connected component associated with variable c includes more than one block. If it is determined that the strongly connected component associated with variable c does not include more than one block, control proceeds to 804. If it is determined that the strongly connected component associated with variable c includes more than one block, control proceeds to 805.

At 804, c is incremented. Control returns to 802.

At 805, the entry blocks and exit blocks of the group of strongly connected components associated with variable c are identified. According to an embodiment of the present invention, entry blocks and blocks in the SCC with edges coming from blocks outside the SCC. Exit blocks are blocks in the SCC with edges going to blocks outside the SCC.

At 806, a new control flow graph is generated for the strongly connected component associated with the variable c. According to an embodiment of the present invention, the new control flow graph includes the nodes defined from all of the blocks from the strongly connected component associated with the variable c as well as an artificial source node and an artificial sink node, edges from the source node to each entry node, edges from each exit node to each sink node, and for each edge q to r in the original control flow graph, if r is not an entry node an added edge from q to r, otherwise an added edge from q to the sink node.

At 807, the procedures at 502-505 illustrated in FIG. 5 are performed on the new control flow graph to identify the immediate sentinel(s).

The time complexity associated for generating execution equivalence information may be described with the relationship O(d×(N+E)). In typical applications, d, the maximum depth of nested loops in a program, is expected to be a constant. Thus, the relationship becomes O(N+E).

FIGS. 5 through 8 are flow charts illustrating methods according to embodiments of the present invention. Some of the techniques and procedures illustrated in these figures may be performed sequentially, in parallel, or in an order other than which is described. It should be appreciated that not all of the techniques and procedures described are required to be performed, that additional techniques and procedures may be added, and that some of the illustrated techniques and procedures may be substituted with other techniques and procedures.

Referring back to FIG. 2, the compiler 200 includes an optimizer unit 250. The optimizer unit 250 may perform procedure inlining and loop transformation. The optimizer unit 250 may also perform global and local optimization. According to an embodiment of the compiler 200, the optimizer unit 250 may utilize the execution equivalent information to optimize the compilation of a program through code motion, elimination methods for data flow analysis, and/or other techniques.

According to an embodiment of the compiler 200, the optimizer unit 250 includes a code motion unit 251. The code motion unit 251 performs global instruction scheduling by utilizing the execution equivalent information. The code motion unit 251 may move an instruction from an execution equivalent predecessor into an execution equivalent successor in an execution equivalence pair. The move may be performed in response to determining that the instruction has no data dependence with any instruction after it in the predecessor block, and the instruction has no data dependence with any instruction in any block guarded by the execution equivalent predecessor and the execution equivalent successor. The code motion unit 251 may also move an instruction from an execution successor into an execution equivalent predecessor in an execution equivalent pair. The move may be performed in response to determining that the instruction has no data dependence with any instruction before it in the successor block, and the instruction has no data dependence with any instruction in any block guarded by the execution equivalent predecessor and the execution equivalent successor.

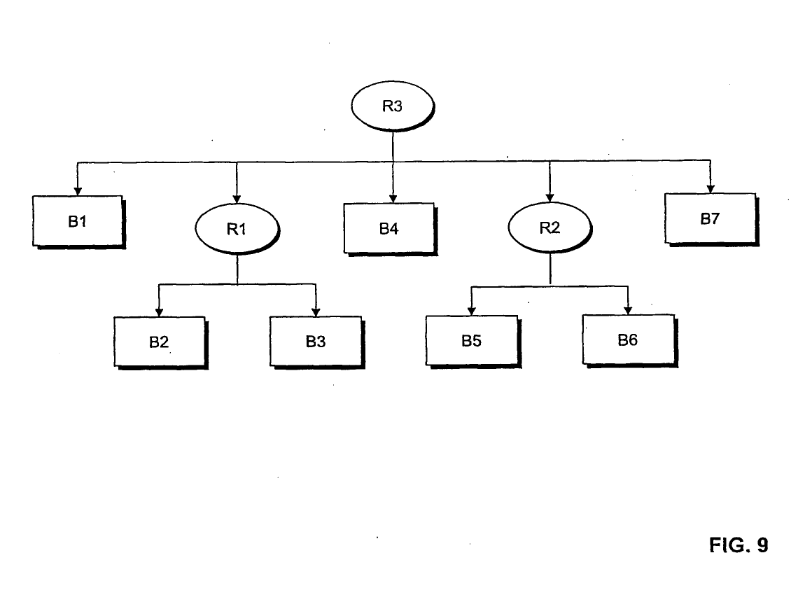

According to an embodiment of the compiler 200, the optimizer unit 250 includes an elimination unit 252. The elimination unit 252 generates a control tree from the execution equivalence information generated by the execution equivalence information generator unit 240. According to one embodiment, a control tree illustrates a hierarchical decomposition of a program's structure. FIG. 9 illustrates an exemplary control tree generated from the execution equivalence information from the control flow graph illustrated in FIG. 4. The elimination unit 252 utilizes the control tree when executing elimination algorithms for data flow analysis. According to an embodiment of the present invention, two passes over a control tree may be made to compute a flow function for each node in the control tree and to evaluate data-flow equations that propagate data-flow information into and through each node. When a program is changed, the updated data-flow information only needs to be propagated to affected regions of the program.

The compiler 200 includes a register allocator 260. The register allocator 260 identifies data in the intermediate representation that may be stored in registers in the processor rather than in memory.

The compiler 200 includes a code generator 270. The code generator 270 converts the intermediate representation into machine or assembly code.

Embodiments of the present invention may be provided as a computer program product, or software, that may include a machine-readable medium having stored thereon instructions. The machine-readable medium may be used to program a computer system or other electronic device. The machine-readable medium may include, but is not limited to, floppy diskettes, optical disks, CD-ROMs, and magneto-optical disks or other type of media/machine-readable medium suitable for storing electronic instructions. The techniques described herein are not limited to any particular software configuration. They may find applicability in any computing or processing environment. The term “machine readable medium” used herein shall include any medium that is capable of storing or encoding a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

In the foregoing specification embodiments of the invention has been described with reference to specific exemplary embodiments thereof. It will, however, be evident that various modifications and changes may be made thereto without departing from the broader spirit and scope of the embodiments of the invention. The specification and drawings are, accordingly, to be regarded in an illustrative rather than restrictive sense.

What is claimed is:

1. A method of compiling code, comprising:
identifying blocks of code that are execution equivalence pairs.

2. The method of claim 1, further comprising moving an instruction from an execution equivalent predecessor into an execution equivalent successor in an execution equivalence pair.

3. The method of claim 2, wherein moving the instruction is performed in response to determining that the instruction has no data dependence with any instruction after the instruction in the block, and the instruction has no data dependence with any instruction in any block guarded by the execution equivalent predecessor and the execution equivalent successor.

4. The method of claim 1, further comprising moving instructions from an execution successor into an execution equivalent predecessor in an execution equivalence pair.

5. The method of claim 4, wherein moving the instruction is performed in response to determining that the instruction has no data dependence with any instruction before the instruction in the block, and the instruction has no data dependence with any instruction in any block guarded by the execution equivalent predecessor and the execution equivalent successor.

6. The method of claim 1, further comprising identifying immediate execution equivalence pairs from the execution equivalence pairs.

7. The method of claim 6, wherein identifying the immediate execution equivalence pairs comprises determining whether an execution equivalent successor in an execution equivalent pair dominates every execution equivalent successor of the execution equivalent predecessor.

8. The method of claim 6, further comprising identifying immediate sentinels.

9. The method of claim 1, wherein identifying immediate sentinels comprises determining whether a second block of code is guarded by a first block of code and an immediate execution equivalent successor of the first block of code.

10. The method of claim 8, further comprising:
generating a control tree from the immediate sentinels; and
utilizing the control tree in elimination algorithms for data flow analysis.

11. An article of manufacture comprising a machine accessible medium including sequences of instructions, the sequences of instructions including instructions which when executed cause the machine to perform:
identifying blocks of code that are execution equivalence pairs.

12. The article of manufacture of claim 11, further comprising instructions which when executed causes the machine to further perform moving an instruction from an execution equivalent predecessor into an execution equivalent successor in an execution equivalence pair.

13. The article of manufacture of claim 12, wherein moving the instruction is performed in response to determining that the instruction has no data dependence with any instruction after the instruction in the block, and the instruction has no data dependence with any instruction in any block guarded by the execution equivalent predecessor and the execution equivalent successor.

14. The article of manufacture of claim 11, further comprising instructions which when executed causes the machine to further perform moving instructions from an execution successor into an execution equivalent predecessor in an execution equivalence pair.

15. The article of manufacture of claim 12, wherein moving the instruction is performed in response to determining that the instruction has no data dependence with any instruction before the instruction in the block, and the instruction has no data dependence with any instruction in any block guarded by the execution equivalent predecessor and the execution equivalent successor.

16. An execution equivalence information generator (EEIG) unit, comprising:
an EEIG manager to generate a summarized control flow graph from a control graph of a program; and
an execution equivalence pair identifier unit to identify execution equivalence pairs from the summarized control flow graph.

17. The apparatus of claim 16, further comprising an immediate execution equivalence pair identifier unit to identify immediate execution equivalence pairs from the execution equivalence pairs.

18. The apparatus of claim 16, further comprising a sentinel identifier unit to identify whether a first block in the program is a sentinel block to a second block in the program.

19. A computer system, comprising:
a memory; and
a processor implementing a compiler having an execution equivalence information generator unit to identify execution equivalence pairs.

20. The computer system of claim 19, wherein the execution equivalence information generator unit identifies immediate execution equivalence pairs.

21. The computer system of claim 19, wherein the execution equivalence information generator unit identifies immediate sentinels.
